(19) United States
(12) Patent Application Publication
(10) Pub. No.: US 2007/0212463 A1
(43) Pub. Date: Sep. 13, 2007

(54) TOMATILLO HUSKING MACHINE

(76) Inventor: Alejandro Flores, Dallas, TX (US)

Correspondence Address: MICHAEL A. O'NEIL, P.C., 5949 SHERRY LANE, SUITE 820, DALLAS, TX, 75225, US

(21) Appl. No.: 11/678,930

(22) Filed: Feb. 26, 2007

Related U.S. Application Data
(60) Provisional application No. 60/781,499, filed on Mar. 10, 2006.

(51) Int. Cl. A23L 1/216

(52) U.S. Cl. 426/482

(57) ABSTRACT

A tomatillo husk removing apparatus comprises a plurality of counter-rotating rollers which seize tomatillo husks while supporting tomatillo fruits thereon thereby removing the tomatillo husks from the tomatillo fruits.

### CLAIM OF PRIORITY

Applicant claims priority based on provisional application Ser. No. 60/781,499, filed Mar. 3, 2006, the entire contents of which are incorporated herein by reference.

### TECHNICAL FIELD

This invention relates generally to separating tomatillo husks from tomatillo fruits, and more particularly to an apparatus and process for automatically removing tomatillo husks without damaging the tomatillo fruit.

### BACKGROUND AND SUMMARY OF THE INVENTION

Tomatilloes are genetically related to tomatoes but differ therefrom in taste, texture, and most importantly in the fact that tomatilloes have husks whereas tomatoes do not. Tomatilloes are an important ingredient in a variety of culinary preparations most importantly salsas; however, tomatilloes cannot be used for anything until the husks thereof are removed.

Heretofore tomatillo husks have been removed manually. This is not a problem when a small number of tomatilloes are prepared for individual or family use. On a commercial scale, however, the manual removal of tomatillo husks is cost prohibitive, particularly in the United States. Therefore, a need exists for the automation of tomatillo husk removal.

The present invention comprises an apparatus and process for automatically removing tomatillo husks which overcomes the foregoing and other difficulties which have long since characterized the prior art. In accordance with the broader aspects of the invention picked but otherwise unprocessed tomatilloes are directed across a series of counter-rotating rollers. The husks of the tomatilloes are seized by the rollers and pulled inwardly while the tomatillo fruit remains supported on top of the rollers. In this manner the tomatillo husks are removed without damage to the tomatillo fruit.

In accordance with more specific aspects of the invention batches of picked but otherwise unprocessed tomatilloes are directed downwardly along an inclined ramp or conveyor into engagement with a series of spaced apart pairs of counter-rotating rollers. A vibrating plate is positioned between each pair of rollers to assure movement of the tomatilloes from one set of rollers to the next. As the tomatilloes pass over the counter-rotating rollers the husks thereof are seized by the rollers and pulled inwardly thereby removing the husks without damaging the tomatillo fruit. As the tomatilloes move from one set of counter-rotating rollers to the next all of the husks thereof are removed. After the tomatilloes have passed over the final set of counter-rotating rollers they are directed to a downwardly inclined ramp or conveyor which delivers the huskless tomatillo fruits for packaging and sale or immediate utilization.

The apparatus for removing husks may further comprise an upper conveyor positioned above the plurality of counter-rollers for directing and maintaining the tomatilloes in continuous mating engagement with the counter-rollers and vibrating plates.

Prior to entering the husk removal apparatus the tomatilloes may be directed through a soaking apparatus. Soaking the tomatilloes softens the husks and enables the husks to be more easily seized between the counter-rollers resulting in a more thorough removal of the husk from the tomatillo fruit than if the tomatillo is not soaked. An inclined conveyor delivers the tomatilloes into a tank having a quantity of water provided therein. The tomatilloes are engaged between a series of lower conveyors and an upper conveyor thereby directing the tomatilloes through the tank and onto a downwardly inclined conveyor which thereafter directs the tomatilloes into the husk removal apparatus.

### BRIEF DESCRIPTION OF THE DRAWINGS

A more complete understanding of the present invention may be had by reference to the following Detailed Description when taken in conjunction with the accompanying Drawings, wherein:

FIG. 1A is an illustration of a tomatillo prior to ripening;

FIG. 1B is an illustration of a fully ripe tomatillo;

FIG. 2 is a perspective view illustrating a tomatillo husk removing apparatus comprising the present invention;

FIG. 3 is a longitudinal sectional view of the tomatillo husk removing apparatus of FIG. 2;

FIG. 3A is an enlargement of a portion of FIG. 3;

FIG. 4 is a longitudinal perspective view illustrating a tomatillo soaking apparatus comprising another component of the present invention;

FIG. 5 is a longitudinal perspective view of a husk removing apparatus comprising a second embodiment of the present invention; and

FIG. 6 is bottom perspective view of one component of the husk removing apparatus of FIG. 5.

### DETAILED DESCRIPTION

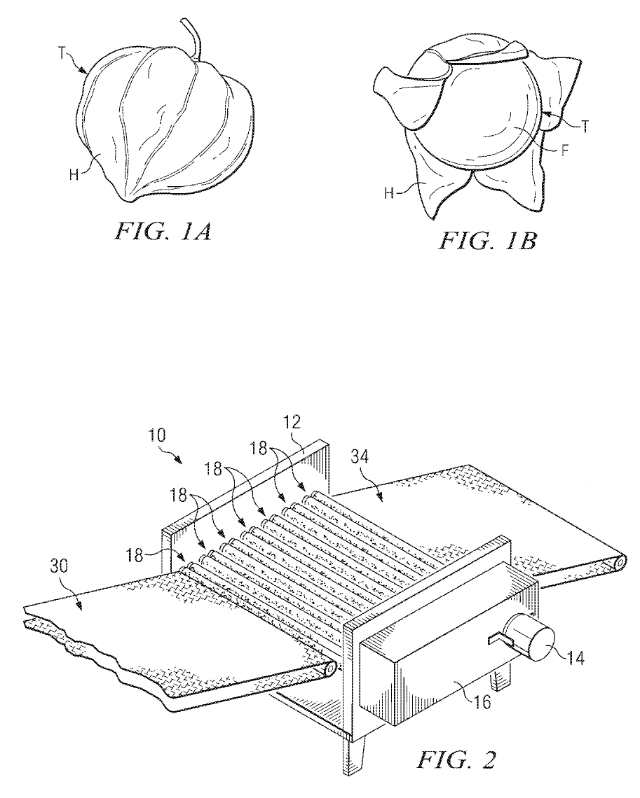

Referring now to the Drawings, and particularly to FIG. 1A thereof, there is shown an unripe tomatillo T. The tomatillo T comprises a more or less spherical fruit (not shown in FIG. 1A) which is similar in size and shape to the fruit of a tomato. The tomatillo fruit is enclosed within a husk H during ripening. The husk H protects the ripening tomatillo fruit from damage.

Referring to FIG. 1B, there is shown a fully ripe tomatillo T. At this stage the husk H of the tomatillo fruit has opened thereby exposing the ripe tomatillo fruit F. When the tomatillo T is at the stage illustrated in FIG. 1B it is ready for picking and use. However, in most instances the tomatillo T cannot be used until the fruit F is separated from the husk H.

Heretofore the separation of tomatillo husks from tomatillo fruits has been an entirely manual operation. The manual removal of tomatillo husks from tomatillo fruits is time consuming and expensive when undertaken on a commercial scale, particularly in the United States. Perhaps for this reason the commercial utilization of tomatilloes in the United States and other industrialized nations has not been widespread.

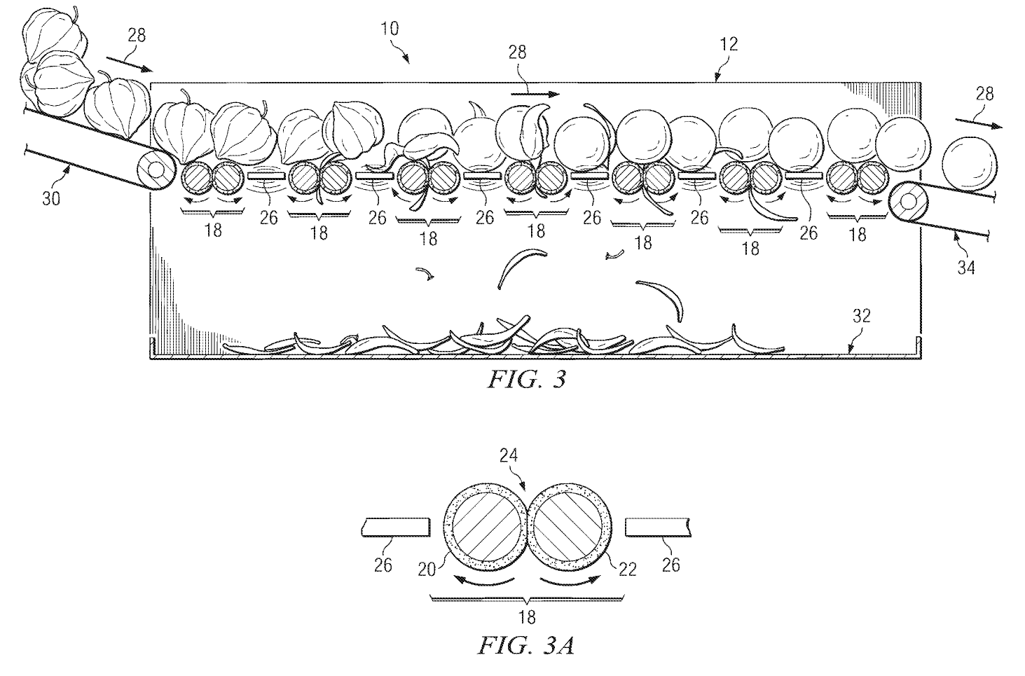

Referring to FIGS. 2 and 3 there is shown an apparatus for removing tomatillo husks 10 comprising the present invention. The apparatus 10 includes a frame 12 which supports the operating components of the apparatus 10. A drive motor 14 is supported on a housing 16 which encloses a roller drive mechanism. The drive motor 14 is operatively connected to the roller drive mechanism contained within the housing 16 which is in turn operatively connected to a plurality of sets of counter-rotating rollers 18.

Referring particularly to FIG. 3A each set of counter-rotating rollers 18 comprises a clockwise (FIG. 3A) rotating roller 20 and a counterclockwise (FIG. 3A) rotating roller 22. The rollers 20 and 22 have inner metal cylinders and outer rubber or plastic sleeves which engage each other under compression passing between the rollers 20 and 22. The sets of rollers 18 comprising the tomatillo husk removing apparatus 10 are separated by vibrating plates 26 which support the tomatillo fruits passing through the apparatus 10 and assure movement thereof along the path defined by the arrows 28 in FIG. 3.

Referring particularly to FIG. 3 tomatilloes having husks thereon are received on an inclined ramp or conveyor 30. The presence of a quantity of tomatillo tomatilloes on the inclined ramp or conveyor 30 assures movement of previously received tomatilloes along the path defined by the arrows 28. As the tomatilloes move across the sets of counter-rotating rollers 18 the husks thereof are seized between the rollers 20 and 22. The function of the rollers 20 and 22 is to remove the husks from the tomatilloes without damaging the tomatillo fruits.

As the tomatillo husks pass through the counter-rotating rollers 20 and 22 they are dropped onto a surface 32 comprising the floor of the frame 12 of the tomatillo husk removing apparatus 10. Movement of the tomatilloes along the path defined by the arrows 28 is assured by the plates 26 positioned between the sets of counter-rotating rollers 18. As indicated above the plates 26 may be vibrated either vertically or in a rocking motion to assure continuous movement of the tomatilloes along the designated path.

After the tomatilloes have moved across all of the sets of counter-rotating rollers 18 comprising the tomatillo husk removing apparatus 10 they are received on an inclined ramp or conveyor 34. From the conveyor 34 the tomatillo fruits having the husks removed therefrom may be directed into food processing machines whereby the tomatilloes are processed and packaged for consumption. Alternatively, the inclined ramp or conveyor 34 may direct the tomatilloes having the husks removed into packaging machinery for delivery to restaurants and other destinations.

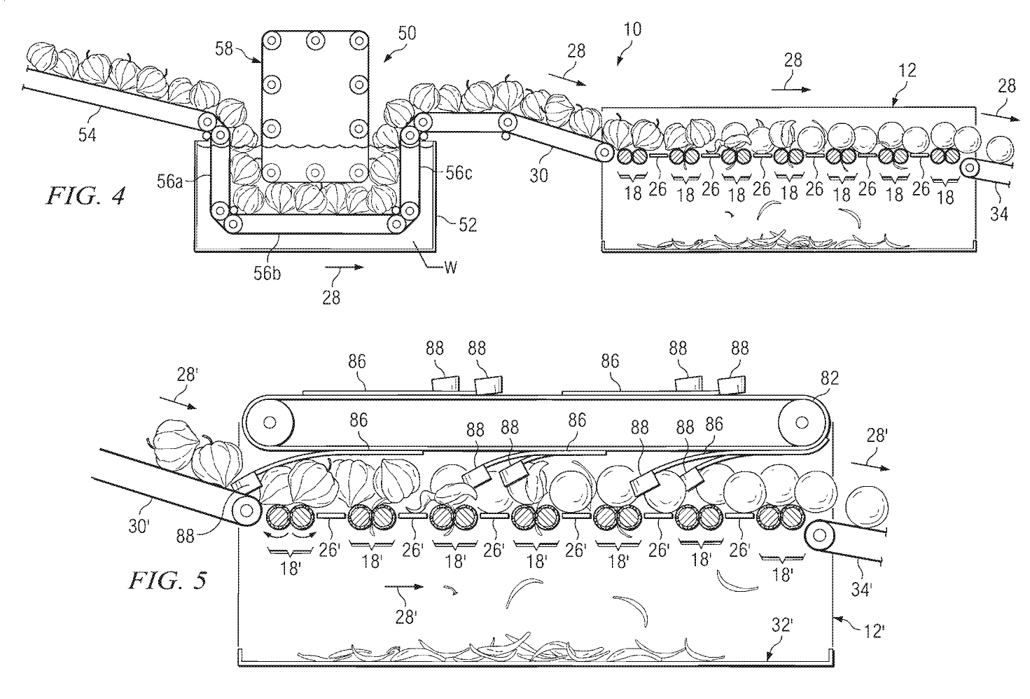

Referring now to FIG. 4 there is shown a tomatillo soaking apparatus 50 which may be used in conjunction with the husk removing apparatus 10. The soaking apparatus 50 comprises a tank 52 having a provided quantity of water W therein. Soaking the tomatilloes softens the husks and enables the husks to be more easily seized in the space 24 between the rollers 20 and 22. A downwardly inclined delivery conveyor 54 delivers the tomatilloes into the soaking apparatus 50 wherein the tomatilloes are received between a series of lower conveyors 56a through 56c and an upper conveyor 58. The tomatilloes are captured between the first lower conveyors 56a and the upper conveyor 58 and are directed through the tank 52 thereafter deposited from the final lower conveyor 56c onto the inclined conveyor 30 for transport into the husk removing apparatus 10.

The lower conveyors 56a through 56c and the upper conveyor 58 rotate in opposing directions in order to propel the tomatilloes through the tank along the path defined by the arrows 28. The lower conveyors 56 and the upper conveyor 58 may be driven by a drive mechanism such as a roller drive mechanism and drive motor or other suitable drive mechanisms know to those skilled in the art of conveyor systems.

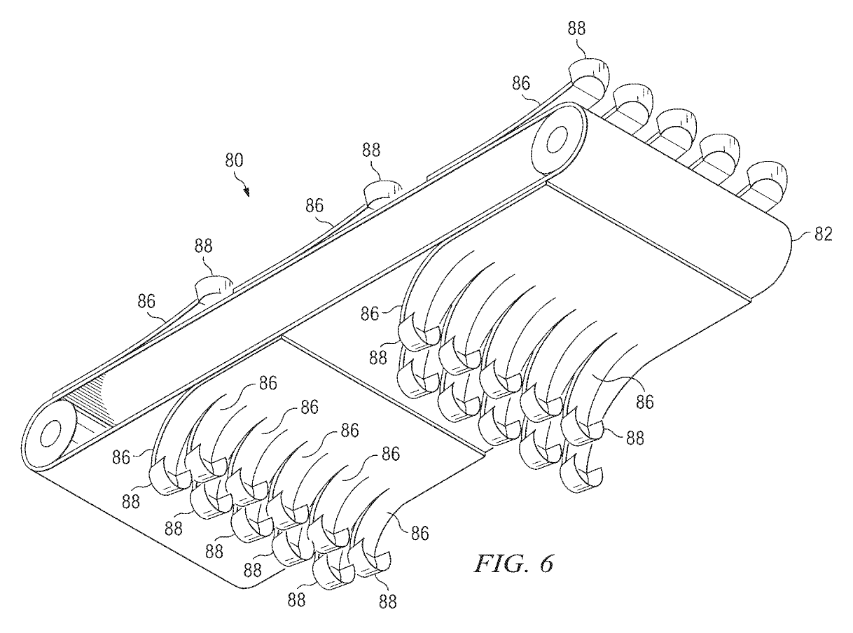

Referring now to FIGS. 5 and 6 there is shown a husk removing apparatus 80 comprising a second embodiment of the present invention. Many of the component parts of the husk removing apparatus 80 are substantially identical in construction and function to component parts of the husk removing apparatus 10 illustrated in FIGS. 1 through 4 and described hereinabove in conjunction therewith. Such identical component parts are designated in FIGS. 5 and 6 with the same reference numerals utilized above in the description of the husk removing apparatus 10, but are differentiated therefrom by means of a prime (′) designation.

The husk removing apparatus 80 differs from the husk removing apparatus 10 shown in FIGS. 1 through 4 in that the husk removing apparatus 80 further comprises an upper conveyor 82 positioned above a plurality of counter-rotating rollers 18′. The upper conveyor 82 comprises a plurality of directing members 86 having paddles 88 on the ends thereof for engaging and directing the tomatilloes. As tomatilloes are received onto the counter-rollers 18′ the tomatilloes are engaged from above by the upper conveyor 82 which thereafter maintains the tomatilloes in continuous mating engagement with the counter-rotating rollers 18′ and vibrating plates 26′ as the tomatilloes travel along the path indicated by arrow 28′. Such continuous mating engagement with the rollers 18′ and vibrating plates 26′ enables the husks to better engage the rollers 18′ thereby resulting in a more thorough removal of the husk from the tomatillo fruit.

The upper conveyor 82 may be a conveyor comprising a belt constrained around a plurality of pulleys or rollers or other suitable conveyor construction known to those skilled in the art. The upper conveyor 82 may be driven by a drive mechanism such as a roller drive mechanism and drive motor or other suitable drive mechanisms know to those skilled in the art of conveyor systems. The directing members 86 and paddles 88 of the upper conveyor 82 may comprise polymers, metals, rubber, and various other materials suitable for transporting foodstuffs known to those skilled in the art of conveyor systems.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A tomatillo husk removing apparatus comprising:
at least one set of counter-rotating rollers for receiving tomatilloes thereon and for seizing the husks of the tomatilloes while supporting the tomatillo fruits thereby removing the tomatillo husks from the tomatillo fruits; and
means for sequentially directing a plurality of tomatilloes into engagement with the counter-rotating rollers.

2. An apparatus for automatically removing tomatillo husks from tomatillo fruits comprising:
a plurality of sets of counter-rotating rollers;
means supporting the set of counter-rotating rollers at spaced apart locations along a predetermined path;
a plurality of support plates positioned between the sets of counter-rotating rollers along the predetermined path;
the rollers comprising each set of counter-rotating rollers being spaced apart to seize tomatillo husks therebetween while supporting tomatilloes thereon; and
means for sequentially directing a plurality of tomatilloes along the predetermined path.

3. A tomatillo husk removing apparatus comprising:
at least one set of counter-rotating rollers for receiving tomatilloes thereon and for seizing the husks of the tomatilloes while supporting the tomatillo fruits thereby removing the tomatillo husks from the tomatillo fruits;
means for sequentially directing a plurality of tomatilloes into engagement with the counter-rotating rollers; and
means for soaking the tomatilloes prior to directing the tomatilloes through the counter-rotating rollers.

4. The apparatus according to claim 3 wherein the means for directing the tomatilloes into engagement with the counter-rotating rollers comprises an upper conveyor positioned above the plurality of counter-rotating rollers.

5. The apparatus according to claim 4 wherein the upper conveyor comprises a plurality of directing members having paddles on the ends thereof for engaging the tomatilloes.

6. The apparatus according to claim 3 wherein the means for soaking the tomatilloes comprises a tank having a quantity of water provided therein and a conveyor system for directing the tomatilloes through the tank.

7. An apparatus for automatically removing tomatillo husks from tomatillo fruits comprising:
a plurality of sets of counter-rotating rollers;
means supporting the set of counter-rotating rollers at spaced apart locations along a predetermined path;
a plurality of support plates positioned between the sets of counter-rotating rollers along the predetermined path;
the rollers comprising each set of counter-rotating rollers being spaced apart to seize tomatillo husks therebetween while supporting tomatilloes thereon;
means for sequentially directing a plurality of tomatilloes along the predetermined path; and
means for soaking the tomatilloes prior to directing the tomatilloes through the counter-rotating rollers.

8. The apparatus according to claim 7 wherein the means for directing the tomatilloes into engagement with the counter-rotating rollers comprises an upper conveyor positioned above the plurality of counter-rotating rollers.

9. The apparatus according to claim 8 wherein the upper conveyor comprises a plurality of directing members having paddles on the ends thereof for engaging the tomatilloes.

10. The apparatus according to claim 7 wherein the means for soaking the tomatilloes comprises a tank having a quantity of water provided therein and a conveyor system for directing the tomatilloes through the tank.

11. A method of removing husks from tomatilloes comprising:
providing a plurality of sets of counter-rotating rollers;
positioning the sets of counter-rotating rollers along a predetermined path;
providing a quantity of tomatilloes having husks thereon;
sequentially directing the tomatilloes comprising the plurality thereof along the predetermined path;
positioning the counter-rotating rollers comprising each set thereof in a spaced apart relationship whereby the counter-rotating rollers seize the husks of the tomatilloes moving along the predetermined path thereby removing the husks of the tomatilloes from the fruits thereof.

12. The method according to claim 11 further comprising the steps of
providing a soaking apparatus; and
directing the provided quantity of tomatilloes through the soaking apparatus prior to sequentially directing the tomatilloes comprising the plurality thereof along the predetermined path

13. A method of removing husks from tomatilloes comprising:
providing a soaking apparatus;
providing a plurality of sets of counter-rotating rollers;
positioning the sets of counter-rotating rollers along a predetermined path;
providing a quantity of tomatilloes having husks thereon;
directing the tomatilloes through the soaking apparatus;
directing the soaked tomatilloes toward the sets of counter-rotating rollers;
sequentially directing the soaked tomatilloes comprising the plurality thereof along the predetermined path;
positioning the counter-rotating rollers comprising each set thereof in a spaced apart relationship whereby the counter-rotating rollers seize the husks of the soaked tomatilloes moving along the predetermined path thereby removing the husks of the tomatilloes from the fruits thereof.
